(19) United States
(12) Patent Application Publication
(10) Pub. No.: US 2020/0398615 A1
(43) Pub. Date: Dec. 24, 2020

(54) TIRE

(71) Applicant: Toyo Tire Corporation, Itami-shi (JP)

(72) Inventor: Kazuki OHTA, Itami-shi (JP)

(73) Assignee: Toyo Tire Corporation, Itami-shi, Hyogo (JP)

(21) Appl. No.: 16/902,557

(22) Filed: Jun. 16, 2020

(30) Foreign Application Priority Data
Jun. 19, 2019 (JP) 2019-113995

(51) Int. Cl. B60C 19/00; B60C 15/06

(52) U.S. Cl. CPC B60C 19/00; B60C 2019/004; B60C 15/0607

(57) ABSTRACT

A tire includes tire frame members including bead cores, a bead filler, an inner liner, side-wall rubber and cushion rubber; and an electronic unit provided at an interface of tire frame members, in which the electronic unit is disposed between the tire frame members; and a carcass ply extending from one bead core to another bead core and including a rubber-coated reinforcement cord, or a belt provided on an outer side of the carcass ply in a tire-radial direction.

### CROSS-REFERENCE TO RELATED APPLICATIONS

This application is based on and claims the benefit of priority from Japanese Patent Application No. 2019-113995, filed on 19 Jun. 2019, the content of which is incorporated herein by reference.

### FIELD

The present invention relates to a tire in which an electronic unit is embedded.

### BACKGROUND

Conventionally, tires in which an electric component such as an RFID is embedded within the rubber structure have been known. With such tires, by an RFID tag embedded in the tire and a reader as an external device carrying out communication, it is possible to perform production control of tires, usage history management, etc.

### SUMMARY

In this regard, in the technology shown in Japanese Unexamined Patent Application, Publication No. 2016-37236, the RF tag is arranged between a stiffener and side rubber, and the RF tag does not contact with fiber members such as the carcass ply. Consequently, the RF tag will move greatly during tire deformation, and there is concern over protection of the RF tag becoming difficult. In addition, with the technology shown in Japanese Unexamined Patent Application, Publication No. 2016-49920, a configuration is shown in which the RF tag is interposed between a carcass ply consisting of fiber layers and a cord reinforcing layer. In this way, in a case of the RF tag being completely interposed by two fiber layers, stress is produced between the fiber layers and RF tag during this interposing process, and there is a possibility of the fiber layer and RF tag being affected by stress at this time. In addition, in the case of arranging the RF tag by configuring so as to be sandwiched between simply two rubber members, it is difficult to set a reference for this arrangement position, and there is a possibility of the arrangement position of the electronic unit varying. As a result thereof, the electronic unit is arranged at an unpreferable position, and there is also a possibility of no longer keeping the function thereof.

The present invention has been made taking account of the above-mentioned problem, and an object thereof is to provide a tire capable of efficiently suppressing movement of an electronic unit during tire deformation, and suitably protecting the electronic unit.

A tire according to a first aspect of the present invention includes: tire frame members including bead cores, a bead filler, an inner liner, side-wall rubber and cushion rubber; and an electronic unit provided at an interface of tire frame members, in which the electronic unit is disposed between the tire frame members; and a carcass ply extending from one bead core to another bead core and including a rubber-coated reinforcement cord, or a belt provided on an outer side of the carcass ply in a tire-radial direction.

According to the present invention, it is possible to provide a tire capable of efficiently suppressing movement of an electronic unit during tire deformation, and suitably protecting the electronic unit.

### BRIEF DESCRIPTION OF THE DRAWINGS

FIG. 1 is a view showing a half section in a tire-width direction of a tire according to a first embodiment of the present invention;

FIG. 2 is a partially enlarged sectional view of a tire according to the first embodiment of the present invention;

FIG. 3A is a view showing an RFID tag in a tire according to the first embodiment of the present invention, protected by a protective member;

FIG. 3B is a view showing a cross section along the line b-b in FIG. 3A;

FIG. 3C is a view showing a cross section along the line c-c in FIG. 3A;

FIG. 4 is a partially enlarged cross-sectional view of a tire according to a second embodiment of the present invention;

FIG. 5A is a view when looking at a peripheral part of the protective member from an outer side in the tire-width direction, in a manufacturing process of a tire according to the second embodiment of the present invention;

FIG. 5B is a view when looking at a peripheral part of the protective member from an outer side in the tire-width direction, in a modified example of a manufacturing process of the tire according to the second embodiment of the present invention;

FIG. 5C is a view showing a rubber sheet of annular shape as a modified example of the protective member, in the tire according to the second embodiment of the present invention;

FIG. 6 is a partially enlarged cross-sectional view of a tire according to a modified example of the second embodiment of the present invention;

FIG. 7 is a partially enlarged cross-sectional view of a tire according to a third embodiment of the present invention;

FIG. 8 is a partially enlarged cross-sectional view of a tire according to a fourth embodiment of the present invention;

FIG. 9 is a partially enlarged cross-sectional view of a tire according to a fifth embodiment of the present invention;

FIG. 10 is a partially enlarged cross-sectional view of a tire according to a sixth embodiment of the present invention;

FIG. 11 is a view showing a cross section prior to interposing the RFID tag by rubber sheets, in a case of not filling rubber into a spring antenna;

FIG. 12 is a view showing a cross section after interposing an RFID tag by rubber sheets, in a case of not filling rubber into a spring antenna;

FIG. 13 is a view showing a cross section after interposing an RFID tag by rubber sheets, in a case of not filling rubber into a spring antenna;

FIG. 14 is a view showing an RFID tag prior to filling rubber into a spring antenna, in a tire according to a seventh embodiment of the present invention;

FIG. 15 is a view showing an RFID tag after filling rubber into a spring antenna, in the tire according to the seventh embodiment of the present invention;

FIG. 16 is a view showing the RFID tag prior to interposing by rubber sheets, in the tire according to the seventh embodiment of the present invention; and

FIG. 17 is a view showing the RFID tag interposed by rubber sheets, in the tire according to the seventh embodiment of the present invention.

### DETAILED DESCRIPTION

### First Embodiment

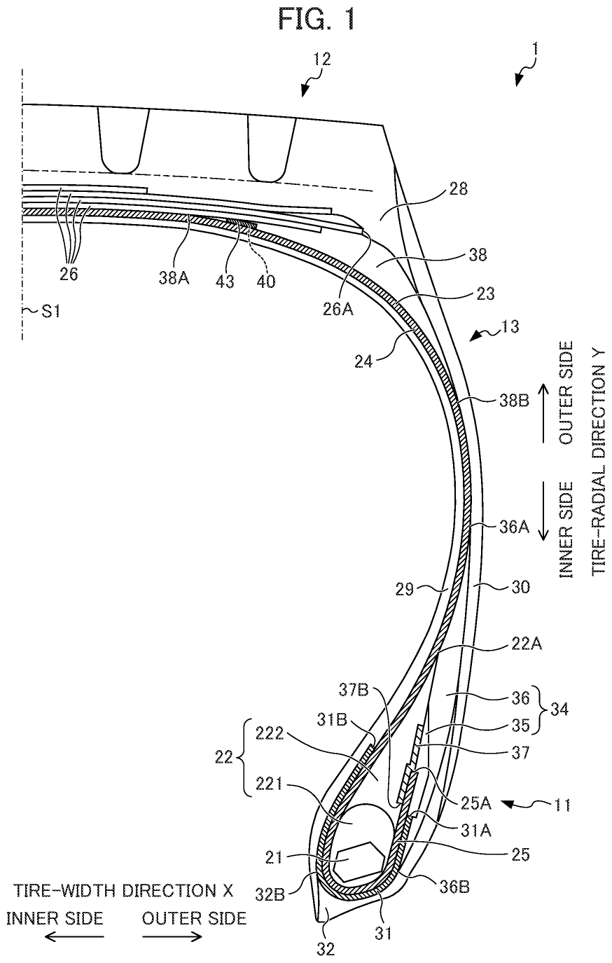

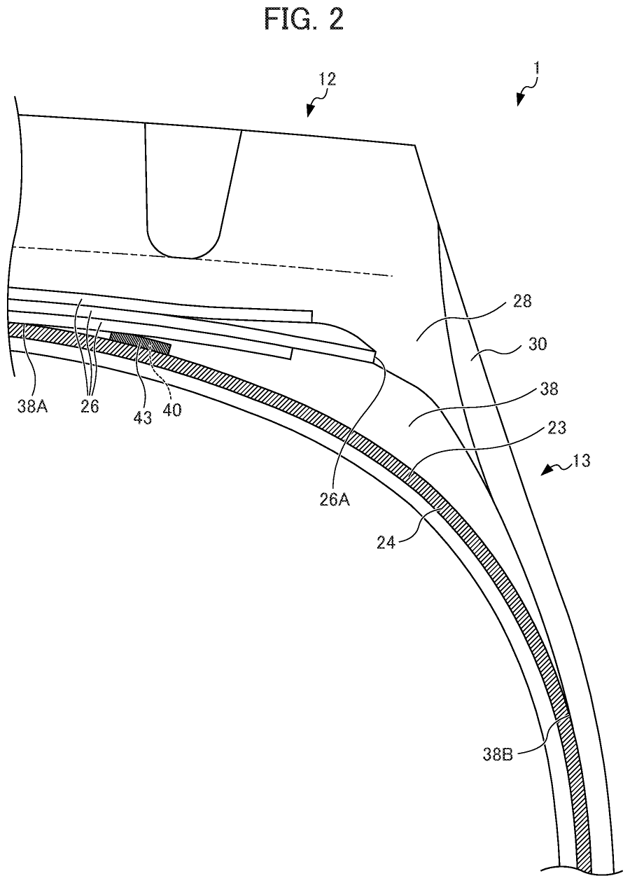

Hereinafter, a first embodiment of the present invention will be explained while referencing the drawings. FIG. 1 is a view showing a half section in a tire-width direction of a tire 1 according to the present embodiment. The basic structure of the tire is left/right symmetric in the cross section of the tire-width direction; therefore, a cross-sectional view of the right half is shown herein. In the drawings, the reference symbol S1 is the tire equatorial plane. The tire equatorial plane S1 is a plane orthogonal to the tire rotation axis, and is positioned in the center of the tire-width direction. Herein, tire-width direction is a direction parallel to the tire rotation axis, and is the left/right direction of the paper plane of the cross-sectional view in FIG. 1. In FIG. 1, it is illustrated as the tire-width direction X. Then, inner-side of tire-width direction is a direction approaching the tire equatorial plane S1, and is the left side of the paper plane in FIG. 1. Outer side of tire-width direction is a direction distancing from the tire equatorial plane S1, and is the right side of the paper plane in FIG. 1. In addition, tire-radial direction is a direction perpendicular to the tire rotation axis, and is the vertical direction in the paper plane of FIG. 1. In FIG. 1, it is illustrated as the tire-radial direction Y. Then, outer-side of tire-radial direction is a direction distancing from the tire rotation axis, and is the upper side of the paper plane in FIG. 1. Inner-side of tire-radial direction is a direction approaching the tire rotation axis, and is the lower side of the paper plane in FIG. 1. The same also applies to FIGS. 2, 4, and 6 to 10.

The tire 1 is a tire for trucks and buses, for example, and includes a pair of beads 11 provided at both sides in the tire width direction, tread 12 forming a contact patch with the road surface, and a pair of sidewalls 13 which extends between the pair of beads and the tread 12.

The bead 11 includes an annular bead core 21 formed by wrapping around several times bead wires made of metal coated with rubber, and a bead filler 22 of tapered shape extending to the outer side in the tire-radial direction of the bead core 21. The bead filler 22 is configured by a first bead filler 221 which covers the outer circumference of the bead core 21, and a second bead filler 222 which is arranged on the outer side in the tire-radial direction of the first bead filler 221. The second bead filler 222 is configured from rubber with a modulus higher than an inner liner 29 and side wall rubber 30 described later. Then, the first bead filler 221 is configured from rubber of an even higher modulus than the second bead filler 222. It should be noted that the first bead filler 221 may be a form not covering the outer circumference of the bead core 21, if at least a part thereof is arranged on the outer side in the tire-radial direction of the bead core 21. In addition, the bead filler 22 may be formed from rubber of one type. In other words, it may not necessarily be divided into the first bead filler 221 and second bead filler 222. The bead core 21 is a member which plays a role of fixing a tire filled with air to the rim of a wheel which is not illustrated. The bead filler 22 is a member provided in order to raise the rigidity of the bead peripheral part and to ensure high maneuverability and stability.

A carcass ply 23 constituting a ply serving as the skeleton of the tire is embedded inside of the tire 1. The carcass ply 23 extends from one bead core to the other bead core. In other words, it is embedded in the tire 1 between the pair of bead cores 21, in a form passing through the pair of side walls 13 and the tread 12. As shown in FIG. 1, the carcass ply 23 includes a ply body 24 which extends from one bead core to the other bead core, and extends between the tread 12 and bead 11, and a ply folding part 25 which is folded around the bead core 21. Herein, a folding end 25A of the ply folding part 25 is positioned more to an inner side in the tire-radial direction than a tire-radial direction outside end 22A of the bead filler 22. The carcass ply 23 is configured by a plurality of ply cords extending in a tire-width direction. In addition, a plurality of ply cords is arranged side by side in a tire circumferential direction. This ply cord as a reinforcement cord is configured by a metal steel cord, or an insulated organic fiber cord such as polyester or polyamide, or the like, and is covered by rubber.

In the tread 12, a plurality of layers of steel belts 26 is provided in the outer side in the tire radial direction of the carcass ply 23. The steel belt 26 is a belt configured by a plurality of steel cords covered by rubber. By providing the steel belts 26, the rigidity of the tire is ensured, and the contact state of the road surface with the tread 12 improves. In the present embodiment, although four layers of steel belts 26 are provided, the number of layered steel belt 26 is not limited thereto.

The tread rubber 28 is provided at the outer side in the tire-radial direction of the steel belt 26. A tread pattern (not illustrated) is provided to the outer surface of the tread rubber 28, and this outer surface serves as a contact surface which contacts with the road surface.

In the vicinity of the outer side in the tire-width direction of the tread 12, i.e. in an end region on the tire-width direction of the steel belt 26 and tread rubber 28, in a region between the carcass ply 23, and the steel belts 26/tread rubber 28, a shoulder pad 38 is provided as a pad. This shoulder pad 38 extends until a region of the outer side in the tire-radial direction of the side wall 13, and part thereof forms an interface between side wall rubber 30 described later. In other words, in the region of the outer side in the tire-radial direction of the side wall 13, a part of the shoulder pad 38 is present on the inner side in the tire width direction of the side wall rubber 30. In other words, in an extended part of the shoulder pad 37, from the tire inner cavity side towards the outer surface side of the tire, the extended part of the shoulder pad 38 and the side wall rubber 30 are laminated in order on the carcass ply 23. In other words, at part of the carcass ply 23, the shoulder pad 38 and side-wall rubber 30 are laminated. The shoulder pad 38 as cushion rubber consists of a rubber member having cushioning, and exhibits a cushion function between the carcass ply 23 and steel belt 26. In addition, since the shoulder pad 38 consists of rubber having a characteristic of low heat buildup, it is possible to suppress heat generation effectively, by extending until the side wall 13. In this way, the shoulder pad 38 is arranged at a tire surface side of the carcass ply 23, and at a tire inner cavity side of the tread rubber 28 and side wall rubber 30.

In the bead 11, side wall 13 and tread 12, an inner liner 29 serving as a rubber layer constituting an inside wall surface of the tire 1 is provided to a tire inner cavity side of the carcass ply 23. The inner liner 29 is configured by air permeation resistant rubber, whereby the air inside the tire inner cavity is prevented from leaking to outside.

In the side wall 13, the side wall rubber 30 constituting the outer wall surface of the tire 1 is provided to the outer side in the tire-width direction of the carcass ply 23. This side wall rubber 30 is a portion which bends the most upon the tire exhibiting a cushioning action, and usually flexible rubber having fatigue resistance is adopted therein.

On the inner side in the tire radial direction of the carcass ply 23 provided around the bead core 21 of the bead 11, a steel chafer 31 serving as a reinforcement ply is provided so as to cover at least part of the carcass ply 23. The steel chafer 31 also extends to the outer side in the tire-width direction of the ply folding part 25 of the carcass ply 23, and an end part 31A of this steel chafer 31 is positioned more to the inner side in the tire-radial direction than the folding end 25A of the carcass ply 23. This steel chafer 31 is a metal reinforcement layer configured by metal steel cords, and is covered by rubber.

Rim strip rubber 32 is provided at the inner side in the tire-radial direction of the steel chafer 31. This rim strip rubber 32 is arranged along the outer surface of the tire, and connects with the side wall rubber 30. This rim strip rubber 32 and side wall rubber 30 are rubber members constituting the outer surface of the tire.

Then, at the outer side in the tire-radial direction of the end part 31A of the steel chafer 31, which is at the outer side in the tire-width direction of the folding part 25 of the carcass ply 23 and bead filler 22, a first pad 35 is provided. This first pad 35 is provided at the outer side in the tire-width direction of at least the folding end 25A of the carcass ply 23. The outer side in the tire-radial direction of the first pad 35 is formed so as to taper as approaching the outer side in the tire-radial direction.

Furthermore, a second pad 36 is provided so as to cover the outer side in the tire-width direction of the first pad 35. In more detail, the second pad 36 is provided so as to cover the outer side in the tire-width direction of part of the steel chafer 31, the first pad 35, part of the second bead filler 222, and part of the ply body 24 of the carcass ply 23. Then, the side wall rubber 30 is arranged at an outer side in the tire-width direction in a tire-radial direction outside region of the second pad 36, and the rim strip rubber 32 is arranged at an outer side in the tire-width direction in a tire-radial direction inside region of the second pad 36. In other words, the second pad 36 is provided between the first pad 35, etc., and the rim strip rubber 32 and side wall rubber 30, which are members constituting the outer surface of the tire.

The first pad 35 and second pad 36 as the cushion rubber constitute the pad member 34, and this pad member 34 is configured from rubber of a higher modulus than the modulus of the tire-radial direction outside portion (second bead filler 222) of the bead filler 22). In more detail, the second pad 36 is configured by rubber of higher modulus than the second bead filler 222, and the first pad 35 is configured by rubber of even higher modulus than the second pad 36. The first pad 35 as a first cushion rubber and second pad 36 as a second cushion rubber have a function of mitigating sudden distortion caused by the local rigidity point of change at the folding end 25A of the carcass ply 23 and the end part 31A of the steel chafer 31.

The rubber sheet 37 serving as an annular-shaped sheet is arranged in the vicinity of the folding end 25A of the carcass ply 23, between the bead filler 22 and pad member 34. The rubber sheet 37 is arranged so as to cover the folding end 25A of the carcass ply 23 from the inner side in the tire-width direction. The rubber sheet 37 is configured from rubber of higher modulus than the second bead filler 222. More preferably, it is configured from rubber of a modulus substantially equal to that of the first pad 35.

Generally, at the folding end 25A of the carcass ply 23, stress tends to concentrate. However, by providing the rubber sheet 37 serving as the aforementioned reinforced rubber sheet, it becomes possible to effectively suppress the concentration of stress. It should be noted that, although the pad member 34 is configured from the first pad 35 and second pad 36 in the present embodiment, the pad member 34 may be configured from one member. However, as mentioned above, by configuring the pad member 34 from the first pad 35 and second pad 36, and further adopting a configuration arranging the rubber sheet 37, it is possible to more effectively suppress the concentration of stress.

It should be noted that the position of the tire-radial direction outside end 37A of the rubber sheet 37 in the present embodiment is located more to the outer side in the tire-radial direction than the tire-radial direction outside end 22A of the bead filler 22. However, the position of the tire-radial direction outside end 37A of the rubber sheet 37 may be made to substantially match the position of the tire-radial direction outside end 22A of the bead filler 22. It should be noted that the rubber sheet 37 preferably adopts a form arranged so as to cover the folding end 25A of the carcass ply 23 from the inner side in the tire-width direction as shown in FIG. 1; however, a configuration covering the folding end 25A of the carcass ply 23 from the outer side in the tire-width direction may be adopted. Even in this case, it is possible to mitigate the concentration of stress.

An RFID tag 40 is embedded as an electrical component in the tire 1 of the present embodiment. The RFID tag 40 is a passive transponder equipped with an RFID chip and an antenna for performing communication with external equipment, and performs wireless communication with a reader (not illustrated) serving as the external equipment. As the antenna, a coil-shaped spring antenna, plate-shaped antenna, and various types of rod-shaped antennas can be used. For example, it may be an antenna formed by printing a predetermined pattern on a flexible substrate. The antenna is established at an antenna length optimized according to the frequency band, etc. to be used. In a storage part inside the RFID chip, identification information such as a manufacturing number and part number is stored.

FIG. 2 is an enlarged cross-sectional view showing the vicinity of an embedded part of the RFID tag 40 in the tire 1 of FIG. 1. The RFID tag 40 (including a state in which at least part is covered by the protective member 43 described later) is arranged at an intersecting position of at least three tire frame members constituting the tire 1. More specifically, a plurality of tire frame members include a rubber member and a fiber member, and the RFID tag 40 is arranged at an intersecting position of at least three tire frame members including at least one fiber member. In more detail, the RFID tag 40 includes at least one fiber member and at least one rubber member, and is arranged at an intersecting position of the at least three tire frame members. Herein, a fiber member covered by rubber is included in the fiber member constituting the tire 1, for example, a carcass ply 23, steel belt 26, steel chafer 31, etc. are included. The tire 1 of the present embodiment includes: the carcass ply 23 as a fiber member, the steel belt 26 as a fiber member arranged on the outer side in the tire-radial direction of the carcass ply 23, and the shoulder pad 38 as a rubber member arranged between the carcass ply 23 and steel belt 26 in a tire-width direction outside region, and the RFID tag 40 is arranged at an intersecting position of the carcass ply 23, steel belt 26 and shoulder pad 38. In other words, in the present embodiment, the RFID tag 40 is arranged at the intersecting position of the three tire frame members including two fiber members.

More preferably, the RFID tag 40 is integrally covered by the protective member 43 consisting of the coating rubber sheet described later, and this protective member 43 is arranged at the intersecting position of the three tire frame members including two fiber members. More specifically, this protective member 43 is sandwiched between the carcass ply 23 and steel belt 26, and contacts with the shoulder pad 38 on the outer side in the tire-width direction.

Herein, the carcass ply 23, steel belt 26 and shoulder pad 38 are each cylindrical tire frame members of annular shape constituting the tire 1 of annular shape. Then, the protective member 43 which protects the RFID tag 40 is arranged so as to contact with the carcass ply 23, steel belt 26 and shoulder pad 38.

So long as arranging the RFID tag 40 at such a position, since the RFID tag 40 will be surrounded by the carcass ply 23, steel belt 26 and shoulder pad 38, it is possible to effectively suppress movement of the RFID tag 40 during tire deformation, and suitably protect the RFID tag 40. In addition, in the present embodiment, while the RFID tag 40 is sandwiched between the carcass ply 23 and steel belt 26, due to contacting with the shoulder pad 38 on the outer side in the tire-width direction, it becomes possible for the generated stress to be mitigated by the existence of the shoulder pad 38, which is the contacting rubber member, while strongly protecting the RFID tag by two fiber members.

In addition, by establishing the intersecting position of three members as a reference for the arrangement position of the RFID tag 40, the variation in the arrangement position of the RFID tag 40 decreases. The possibility of the RFID tag 40 being arranged mistakenly at an unpreferable position also decreases, and it is thereby possible to appropriately keep the function of the RFID tag 40.

In addition, so long as being such a position, since it is possible to arrange the RFID tag 40 at the most distant position to the inner side in the tire-width direction from the end part 26A of the steel belt 26, it is hardly influenced by the generated stress at the circumference of the end part 26A of the steel belt 26.

It should be noted that the shoulder pad 38 is the cushion rubber which has a cushioning property. Consequently, so long as arranging the RFID tag 40 at this portion, it is possible to absorb the strain produced at the periphery of the RFID tag 40. In addition, the shoulder pad is low heat generation. Consequently, the RFID tag 40 provided at such a position is hardly influenced by the heat generation of rubber during use. Even when considering these points, the intersecting position of the carcass ply 23, steel belt 26 and shoulder pad 38 is suitable as the embedding position of the RFID tag 40.

Furthermore, if the RFID tag 40 is arranged at the intersecting position of the carcass ply 23, steel belt 26 and shoulder pad 38, the RFID tag 40 will not be removed in the case of performing retread. In other words, since the portion removed in retread is a more outer side in the tire-radial direction than at least the steel belt 26, among the tread rubber 28, if arranging the RFID tag 40 at the intersecting position of the carcass ply 23, steel belt 26 and shoulder pad 38, the RFID tag 40 can be continuously used without being removed. Also in this point, the intersecting position of the carcass ply 23, steel belt 26 and shoulder pad 38 is suitable as the embedding position of the RFID tag 40.

It should be noted that, when defining the modulus of the shoulder pad 38 as a reference, the side-wall rubber 30 is preferably set as a modulus of 0.4 to 0.7 times that of the shoulder pad 38. In addition, the tread rubber 28 is preferably set as a modulus of 0.4 to 0.9 times that of the shoulder pad 38. By setting such a modulus, it is possible to keep a balance between flexibility and rigidity as a tire. It should be noted that the modulus indicates 100% elongation modulus (M100) under a 23° C. atmosphere, measured in accordance with “3.7 stress at a given elongation, S” of JIS K6251:2010.

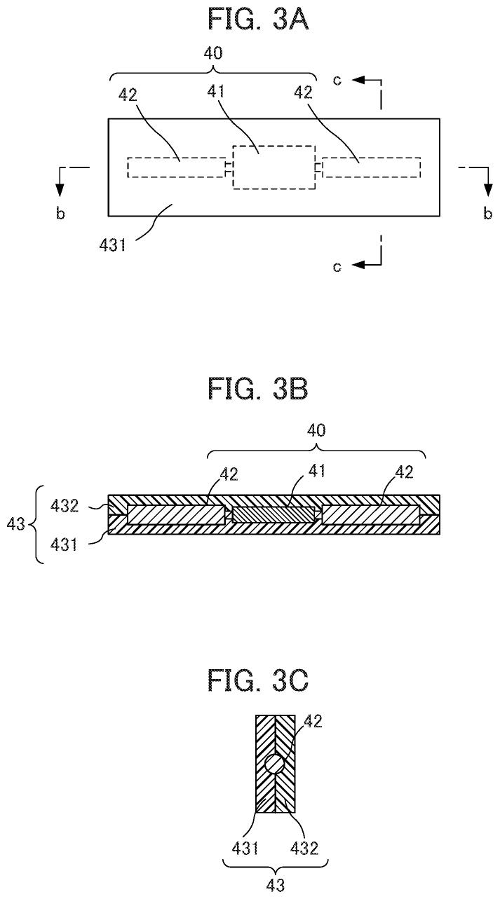

Herein, the RFID tag 40 is covered by the coating rubber sheets 431, 432 constituting the protective member 43. This point will be explained while referencing FIGS. 3A to 3C.

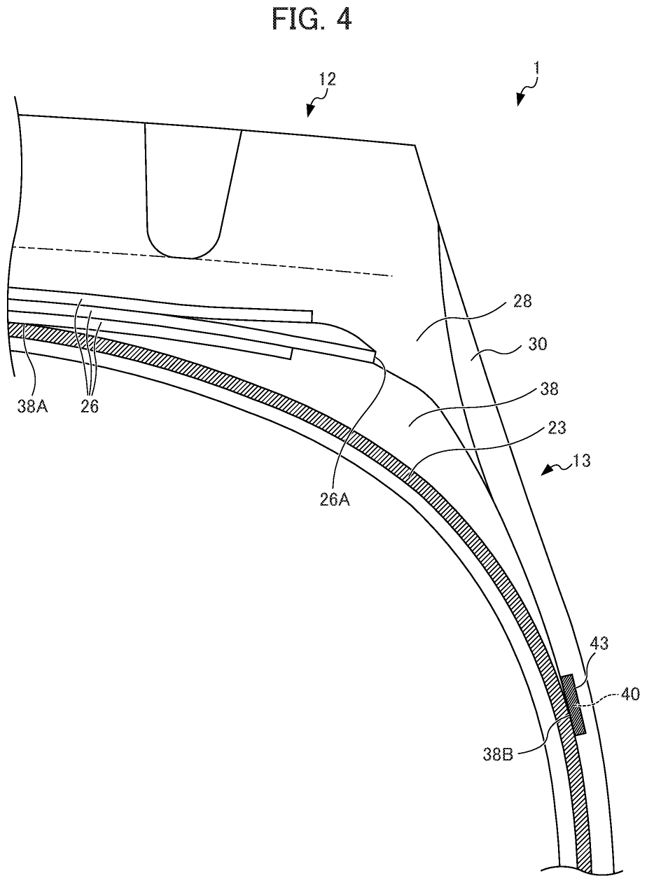

FIG. 3A is a view showing the RFID tag 40 covered by the protective member 43 configured by a rubber sheet. In FIG. 4A, the RFID tag 40 is covered and hidden by the coating rubber sheet 431 described later. FIG. 3B is a cross-sectional view along the line b-b in FIG. 3A, and FIG. 3C is a cross-sectional view along the line c-c in FIG. 3A.

The RFID tag 40 includes an RFID chip 41 and antenna 42 for performing communication with external equipment. As the antenna 42, a coil-shaped spring antenna, plate-shaped antenna, and various types of rod-shaped antennas can be used. For example, it may be an antenna formed by printing a predetermined pattern on a flexible substrate. When considering the communicability and flexibility, a coil-shaped spring antenna is the most preferable. The antenna is established at an antenna length optimized according to the frequency band, etc. to be used.

The protective member 43 is configured from two coating rubber sheets 431, 432 which protect by sandwiching the RFID tag 40.

The protective member 43 is configured by rubber of a predetermined modulus, for example. Herein, the modulus indicates 100% elongation modulus (M100) under a 23° C. atmosphere, measured in accordance with “3.7 stress at a given elongation, S” of JIS K6251:2010.

As the rubber adopted in the protective member 43, rubber at least having a higher modulus than the side wall rubber 30 is used. For example, rubber having a higher modulus than the side wall rubber 30 and lower modulus than the shoulder pad 38 is used.

For example, with the modulus of the side wall rubber 30 as a reference, as the rubber used in the protective member 43, it is preferable to use rubber of a modulus 1.1 to 1.8 times. At this time, as the rubber of the shoulder pad 38, rubber of a modulus 1.6 to 3 times that of the side wall rubber, for example, rubber of a modulus on the order of 2 times thereof, may be used. It should be noted that, if emphasizing reinforcement of the protection of the RFID tag 40, rubber of a modulus higher than the shoulder pad 38 may be adopted as the rubber used in the protective member 43.

In addition, the protective member 43 may be configured from a short-fiber filler mixed rubber. As the short-fiber filler, for example, it is possible to use insulating short fibers like organic short fibers such as aramid short fibers and cellulose short fibers; inorganic short fibers such as ceramic short fibers as in alumina short fiber, and glass short fiber. By mixing such short-fiber fillers into rubber, it is possible to raise the strength of the rubber. In addition, as the protective member 43, a rubber sheet in the vulcanized state may be used. The rubber sheet in a vulcanized state does not plastically deform as raw rubber, and thus can appropriately protect the RFID tag 40. However, if considering the pasting workability during the manufacturing process, or stabilizing of the rubber structures by integrating with other rubber members when vulcanizing, it is more preferable to use a rubber sheet of predetermined thickness in state prior to vulcanization as the protective member 43.

In addition, as the protective member 43, an organic fiber layer from polyester fibers or polyamide fibers may be provided. It is also possible to embed an organic fiber layer in the two coating rubber sheets 431, 432.

Next, the manufacturing process of the tire 1 will be explained. The RFID tag 40 covered by the protective member 43 is mounted before the vulcanization process in the manufacturing process of the tire. In the manufacturing process of the tire 1 of the present embodiment, the protective member 43 covering the RFID tag 40 is pasted to the carcass ply 23.

Subsequently, the shoulder pad 38 is pasted to the carcass ply 23. At this time, the pasting position of the protective member 43 and shoulder pad 38 are positioned so that the position of the protective member 43 covering the RFID tag 40 and the position of the tire-width direction inside end 38A of the shoulder pad 38 substantially match. Herein, the position overlapping with the protective member 43 in the vicinity of the tire-width direction inside end 38A of the shoulder pad 38 may be partially eliminated. It should be noted that, after pasting the shoulder pad 38 on the carcass ply 23, the RFID tag 40 may be pasted so that an end part in a cross-sectional view in the tire-width direction (refer to FIGS. 1 and 2) presses down the tire-width direction inside end 38A of the shoulder pad 38 of tapered shape. At this time, the protective member covering the RFID tag 40 may be pasted so as to straddle the carcass ply 23 and shoulder pad 38, at a border region of the carcass ply 23 and shoulder pad 38.

Further thereafter, the steel belt 26 is pasted so as to cover the outer side in the tire-radial direction of the carcass ply 23 and shoulder pad 38. The RFID tag 40 covered by the protective member 43 is arranged at the intersecting position of the three tire frame members including the two fiber members, i.e. the carcass ply 23, steel belt 26 and shoulder pad 38.

At this time, the coating rubber of the carcass ply 23, the coating rubber of the steel belt 26 and the shoulder pad 38 are in the state of raw rubber prior to vulcanization; therefore, the RFID tag 40 may be pasted to the shoulder pad 38 or side-wall rubber 30 using the adhesive property thereof. Alternatively, in a case of the adhesive property being low or the like, it may be pasted using an adhesive or the like.

The respective rubber members, etc. constituting the tire are assembled in this way, whereby the green tire is formed. Subsequently, the green tire in which the respective constituent members including the RFID tag 40 are assembled is vulcanized in the vulcanization process to manufacture the tire.

In this way, in the present embodiment, during tire manufacture, since it is possible to paste the RFID tag 40 covered by the protective member 43 to the coating rubber, etc. of the carcass ply 23 in the raw rubber state, the assembly work of the RFID tag 40 in the manufacturing process of the tire is easy. In particular, since the carcass ply 23 has a certain level of rigidity, the mounting work of the RFID tag 40 covered by the protective member 43 is easy.

In addition, if configuring the protective member 43 by the two coating rubber sheets 431, 432, since it is possible to thinly form the RFID tag 40 including the protective member 43, it is suitable upon embedding the tire 1. In addition, when assembling the RFID tag 40 to the constituent members of the tire 1 prior to vulcanization, the RFID tag 40 covered by the coating rubber sheets can be installed very easily. For example, at a desired position of a member such as the border region of a plurality of rubber members prior to vulcanization, it is possible to appropriately paste the RFID tag 40 covered by the coating rubber sheets 431, 432 using the adhesiveness of the raw rubber. In addition, by also establishing the coating rubber sheets 431, 432 as raw rubber prior to vulcanization, it is possible to more easily paste by employing the adhesiveness of the coating rubber sheet itself as well.

However, the protective member 43 is not limited to the form configured by two coating rubber sheets, and can adopt various forms. For example, so long as the coating rubber sheets constituting the protective member is covering at least part of the RFID tag 40, effects can be obtained such as an improvement in workability in the manufacturing process and stress mitigation. Consequently, a configuration may be adopted which covers only one side of the RFID tag 40 by the one coating rubber sheet 431 serving as the protective member. In addition, for example, it may be a configuration wrapping one rubber sheet around the entire circumference of the RFID tag 40, or a configuration attaching the protective member in the form of a potting agent of high viscosity along the entire circumference of the RFID tag 40. Even if a configuration by such coating rubber, it will be possible to appropriately protect the RFID tag 40.

It should be noted that the RFID tag 40 covered by the protective member 43 is embedded in the tire 1 so that the direction in which the antenna extends, i.e. the longitudinal direction thereof, becomes the direction of the tangential line relative to the circumferential direction of the tire 1, for example, i.e. direction orthogonal to the paper plane in the cross-sectional view of FIGS. 1 and 2. In addition, the coating rubber sheets 431, 432 are embedded in the tire 1 in a form such that aligns in the tire-radial direction. In other words, in the manufacturing process, one surface of either one of the coating rubber sheets 431, 432 is pasted to a constituent member of the tire 1 prior to vulcanization, e.g., the carcass ply 23. Then, the RFID tag 40 covered by the protective member 43 is arranged between the carcass ply 23 and steel belt 26. By establishing such a form, stress will hardly act on the RFID tag 40, even when the tire 1 deforms. In addition, in the manufacturing process, the work of attaching the RFID tag 40 covered by the protective member 43 becomes easy.

It should be noted that the RFID tag 40 is preferably arranged at the intersecting position of the carcass ply 23, steel belt 26 and shoulder pad 38, in a state covered by the above such protective member 43; however, it may be arranged at the intersecting position of the carcass ply 23, steel belt 26 and shoulder pad 38 directly without covering by the protective member 43. If arranging the uncovered RFID tag 40 at the intersecting position of the carcass ply 23, steel belt 26 and shoulder pad 38 directly, the fluctuation in thickness of the rubber member at the portion where the RFID tag 40 is arranged decreases, and the uniformity of the tire improves. In addition, in the work for embedding the RFID tag 40 at such a position, the removal of air also becomes easier by the volume of the embedded object being smaller. In addition, by a process of covering the RFID tag 40 by the protective member being eliminated, the work time shortens.

It should be noted that, in the present embodiment, the RFID tag 40 is embedded in the tire as the electronic unit; however, the electronic unit embedded in the tire is not limited to an RFID tag. For example, it may be various electronic units such as a sensor which carries out wireless communication. In addition, since the electronic unit handles electrical information such as the transmission of electrical signals, there is a possibility of the performance declining due to metal components being present in the vicinity. In addition, there is a possibility of the electronic unit being damaged by excessive stress acting thereon. Therefore, it is possible to obtain the effects of the present invention also in the case of embedding various electronic units in a tire. For example, the electronic unit may be a piezoelectric element or strain sensor.

According to the tire 1 of the present embodiment, the following effects are exerted.

(1) The tire 1 according to the present embodiment includes a plurality of tire frame members which constitute the tire, and the RFID tag 40 as an electronic unit, in which the plurality of tire frame members include rubber members and fiber members, and the RFID tag 40 is arranged at the intersecting position of the at least three tire frame members including at least one fiber member. It is thereby possible to effectively suppress movement of the RFID tag 40 during tire deformation, and thus suitably protect the RFID tag 40. In addition, by defining the intersecting position of three members as a reference for the arrangement position of the RFID tag 40, variation in the arrangement position of the RFID tag 40 decreases. The possibility of the RFID tag 40 being mistakenly arranged at an unpreferable position also decreases, and it is thereby possible to appropriately keep the function of the RFID tag 40.

(2) The three tire frame members including the one fiber member of the tire 1 according to the present embodiment are respectively annular members formed in a ring shape. In this way, even if the three tire frame members are annular members constituting the tire 1 of ring shape, it is possible to obtain the aforementioned effects.

(3) In the RFID tag 40 of the tire 1 according to the present embodiment, the RFID tag 40 is arranged at the intersecting position of the at least three tire frame members including at least two fiber members. It thereby becomes possible to firmly protect the RFID tag by two fiber members.

(4) The fiber members of the tire 1 according to the present embodiment include the carcass ply 23 and the steel belt 26 arranged at the outer side in the tire-radial direction of the carcass ply 23, the rubber member includes the shoulder pad 38 arranged between the carcass ply 23 and steel belt 26 at the tire-width direction outside part; and the RFID tag 40 is arranged at the intersecting position of the carcass ply 23, steel belt 26 and shoulder pad 38. So long as being such a configuration, it becomes possible for the generated stress to be mitigated by the presence of the shoulder pad 38, which is a rubber member, while firmly protecting the RFID tag 40 by the two fiber members of the carcass ply 23 and steel belt 26.

(5) At least part of the RFID tag 40 of the tire according to the present embodiment is covered by the coating rubber sheets 431, 432, and the coating rubber sheets covering the RFID tag 40 is arranged at the intersecting position of the at least three tire frame members including at least one fiber member. It is thereby possible to easily mount the RFID tag 40 to the constituent member of the tire 1 prior to vulcanization.

(6) With the RFID tag 40 of the tire 1 according to the present embodiment, the RFID tag 40 is arranged at the intersecting position of the at least three tire frame members including at least one fiber member and at least one rubber member. It thereby becomes possible to mitigate the generated stress by the presence of the rubber member, while firmly protecting the RFID tag 40 by the fiber member.

### Second Embodiment

Next, a tire according to a second embodiment will be explained while referencing the drawings. It should be noted that, in the following explanation, the same reference number will be assigned for configurations which are the same as the first embodiment, and detailed explanations thereof will be omitted.

FIG. 4 is an enlarged cross-sectional view showing the vicinity of the embedded part of the RFID tag 40 in the tire 1 of the present embodiment. As shown in FIG. 4, the RFID tag 40 (including a state in which at least part is covered by the protective member 43) is arranged at the intersecting position of the three tire frame members including one fiber member. More specifically, the tire 1 of the present embodiment includes the carcass ply 23 as a fiber member, the shoulder pad 38 as a rubber member arranged on the tire outer surface side of the carcass ply 23, and the side-wall rubber 30 as a rubber member arranged on the tire outer surface side of the carcass ply 23 and shoulder pad 38, in which the RFID tag 40 is arranged at the intersecting position of the carcass ply 23, shoulder pad 38 and side-wall rubber 30.

Then, in the present embodiment, the RFID tag 40 is more preferably covered by the protective member 43 consisting of coating rubber sheets, and this protective member 43 is arranged at the intersecting position of the three tire frame members including one fiber member. More specifically, this protective member 43 is arranged in the border region of the carcass ply 23 and shoulder pad 38 so as to straddle the border region of the carcass ply 23 and shoulder pad 38. In other words, this protective member 43 is pasted so that an end part in a cross-sectional view in the tire-width direction (refer to FIG. 4) presses the tire-radial direction inside end 38B of the shoulder pad 38 of tapered shape. Then, with this protective member 43, the tire outer surface side is covered by the side-wall rubber 30.

Herein, the carcass ply 23, shoulder pad 38 and side-wall rubber 30 are respectively tire frame members of annular shape constituting the tire 1 of annular shape. Then, the protective member 43 preserving the RFID tag 40 is arranged so as to make surface contact with the carcass ply 23, shoulder pad 38 and side-wall rubber 30.

Even if arranging the RFID tag 40 at such a position, since the RFID tag 40 will be surrounded by the carcass ply 23, shoulder pad 38 and side-wall rubber 30, it is possible to effectively suppress movement of the RFID tag 40 during tire deformation, and suitably protect the RFID tag 40. In addition, in the present embodiment, since the RFID tag 40 contacts with the shoulder pad 38 and side-wall rubber 30, while being retained at the carcass ply 23, it becomes possible to mitigate the generated stress by the presence of the shoulder pad 38 and side-wall rubber 30, which are contacting rubber members, while effectively suppressing movement of the RFID tag 40 by the fiber member. Then, by defining the border region of a plurality of tire frame members, the border region B of the carcass ply 23 and shoulder pad 38 in the present embodiment, as a reference for the arrangement position of the RFID tag 40, the variation in the arrangement position of the RFID tag 40 decreases. The possibility of the RFID tag 40 being mistakenly arranged at an unpreferable position from an aspect of stress, distortion or the like also decrease, whereby it is possible to appropriately maintain the function of the RFID tag 40.

In addition, by arranging the RFID tag 40 at a shoulder part, i.e. the tire-radial direction outside vicinity of the side wall, it is possible to arrange the RFID tag 40 at a position sufficiently distanced from the bead core 21 made of metal, which has a possibility of adversely influencing communication. Herein, the bead core 21 is formed in a ring shape by laminating and winding a bead wire made of metal; therefore, it is a metal member having a particularly high possibility of adversely influencing communication. In addition, when considering communication quality, it is preferable for the RFID tag 40 to be arranged in a portion of the tire 1 as close as possible to the outer surface. Assuming that the RFID tag 40 were arranged at the inner cavity side of the carcass ply 23, the communication quality would drop due to being distanced from the outer surface of the tire 1. Furthermore, in the case of the carcass ply 23 being metal, if arranging the RFID tag 40 at the inner cavity side of the carcass ply 23, the communication quality will decline remarkably. When considering these points, the intersecting position of the carcass ply 23, shoulder pad 38 and side-wall rubber 30 is suitable as an embedding position of the RFID tag 40.

In addition, if considering the matter of embedding the RFID tag 40 during the manufacturing process of the tire, it is preferable to arrange the RFID tag 40 at the intersecting position of three tire frame members constituting the tire. For example, in the case of interposing the RFID tag 40 between layers of ribbon-like rubber members which are wound, the timing, etc. at which pasting the RFID tag 40 to the ribbon-like rubber member becomes complicated. In addition, in the case of arranging the RFID tag 40 by simply sandwiching between two rubber members, it is difficult to set a reference for the arrangement position thereof, and there is a possibility of the arrangement position of the electronic unit varying. On the other hand, so long as arranging at the intersecting position of the three tire frame members as in the present embodiment, upon precisely pasting the RFID tag 40 in the molding process of the tire at the border region of a first tire frame member configured from a fiber member (carcass ply 23 in the present embodiment) and a second tire frame member configured from a rubber member (shoulder pad 38 in the present embodiment), it is possible to interpose the RFID tag 40 by overlapping a first tire frame member (side-wall rubber 30 in the present embodiment) thereon. Even when considering these points, the intersecting position of the carcass ply 23, shoulder pad 38 and side-wall rubber 30 is suitable as the embedding position of the RFID tag 40.

It should be noted that the shoulder pad 38 has a cushioning property. Consequently, so long as arranging the RFID tag 40 at this portion, it is possible to absorb the strain produced at the periphery of the RFID tag 40. In addition, the shoulder pad is low heat generation. Consequently, the RFID tag 40 provided at such a position is hardly influenced by the heat generation of rubber during use. Even when considering these points, the intersecting position of the carcass ply 23, shoulder pad 38 and side-wall rubber 30 is suitable as the embedding position of the RFID tag 40.

Furthermore, so long as the RFID tag 40 is arranged at the intersecting position of the carcass ply 23, shoulder pad 38 and side-wall rubber 30, even in the case of performing retread, the RFID tag 40 will not be removed. In other words, since the portion removed in retread is a more outer side in the tire-radial direction than at least the steel belt in the tread rubber 28, if arranging the RFID tag 40 at the intersecting position of the carcass ply 23, shoulder pad 38 and side-wall rubber 30, the RFID tag 40 will not be removed, and can be used continuously. In this point as well, the intersecting position of the carcass ply 23, shoulder pad 38 and side-wall rubber 30 is suitable as the embedding position of the RFID tag 40.

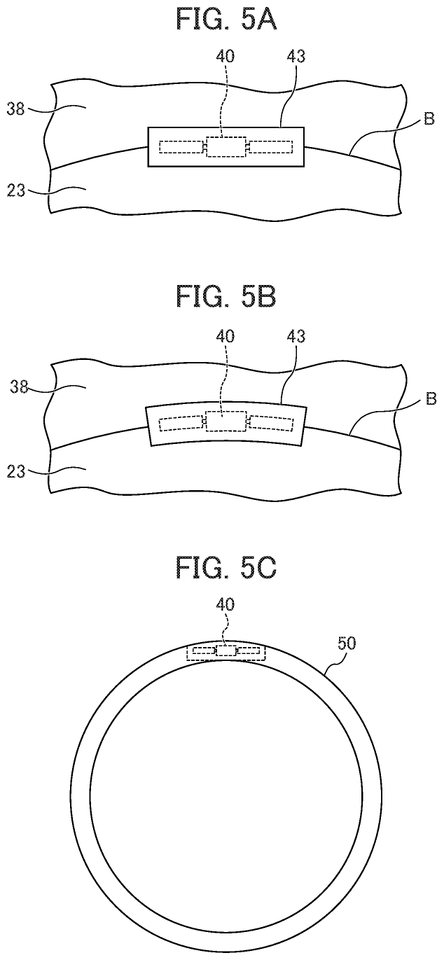

Next, the manufacturing process of the tire 1 will be explained. FIG. 5A is a view when looking from the outer side in the tire-width direction of a peripheral part of the protective member 43 during the manufacturing process, and is a view when pasting the protective member 43 covering the RFID tag 40 to a border region B of the carcass ply 23 and shoulder pad 38.

The RFID tag 40 covered by the protective member 43 is mounted prior to the vulcanization process in the manufacturing process of the tire. As shown in FIG. 5A, in the manufacturing process of the tire 1 in the present embodiment, the protective member 43 covering the RFID tag 40 is pasted so as to straddle the carcass ply 23 and shoulder pad 38 in the border region B of the carcass ply 23 and shoulder pad 38. In other words, this protective member 43 is pasted so that an end part in a cross-sectional view in the tire-width direction (refer to FIG. 4) presses the tire-radial direction inside end 38B of the shoulder pad 38 of tapered shape. By pasting the protective member 43 at such a position, it is possible to partially assist the joining between tire frame members, i.e. joining of the carcass ply 23 and shoulder pad 38.

In addition, by defining a border region between a plurality of rubber members, the border region B of the carcass ply 23 and shoulder pad 38 in the present embodiment, as a reference for the arrangement position of the RFID tag 40, the variation in arrangement position of the RFID tag 40 decreases. The possibility of the RFID tag 40 being mistakenly arranged at an unpreferable position from an aspect of stress, distortion or the like also decrease, whereby it is possible to appropriately maintain the function of the RFID tag 40.

Subsequently, in FIG. 5A, the side-wall rubber which is not shown (refer to FIG. 5) is pasted so as to cover the protective member 43 pasted to the border region B of the carcass ply 23 and shoulder pad 38. The RFID tag 40 covered by the protective member 43 is thereby arranged at the intersecting position of at least three tire frame members constituting the tire 1, the intersecting position of the carcass ply 23, shoulder pad 38 and side-wall rubber 30 in the present embodiment.

At this time, the coating rubber of the carcass ply 23, shoulder pad 38 and side-wall rubber 30 are in the state of raw rubber prior to vulcanization; therefore, the RFID tag 40 covered by the protective member 43 may be pasted to these members using the adhesiveness thereof. Alternatively, in a case of the adhesive property being low or the like, it may be pasted using an adhesive or the like.

The respective rubber members, etc. constituting the tire are assembled in this way, whereby the green tire is formed. Subsequently, the green tire in which the respective constituent members including the RFID tag 40 are assembled is vulcanized in the vulcanization process to manufacture the tire.

In this way, in the present embodiment, during tire manufacture, since it is possible to paste the RFID tag 40 covered by the protective member 43 to the coating rubber of the carcass ply 23 and the shoulder pad 38 which are in the raw rubber state, the assembly work of the RFID tag 40 in the manufacturing process of the tire is easy. In particular, since the carcass ply 23 has a certain level of rigidity, the mounting work of the RFID tag 40 covered by the protective member 43 is easy.

It should be noted that the following such manufacturing process may be adopted as a modified example of the manufacturing process of the tire 1. In other words, the protective member 43 covered by the RFID tag 40 is pasted to a side of the side-wall rubber 30, and subsequently, the side-wall rubber 30 to which the protective member 43 is pasted is then pasted to the carcass ply 23 and shoulder pad 38. Herein, when pasting the side-wall rubber 30 to the carcass ply 23 and shoulder pad 38, the protective member 43 is pasted to the side-wall rubber 30 so that the protective member 43 is arranged at the border region B of the carcass ply 23 and shoulder pad 38. Even in a case of adopting such a process, the RFID tag 40 covered by the protective member 43 is arranged at the intersecting position of at least three tire frame members constituting the tire 1, i.e. the intersecting position of the carcass ply 23, shoulder pad 38 and side-wall rubber 30. Consequently, it is possible to effectively suppress movement of the RFID tag 40 during tire deformation, and suitably protect the RFID tag 40.

It should be noted that the RFID tag 40 covered by the protective member 43 is embedded in the tire 1 so that the direction in which the antenna extends, i.e. the longitudinal direction thereof, becomes the direction of the tangential line relative to the circumferential direction of the tire 1, for example, i.e. direction orthogonal to the paper plane in the cross-sectional view of FIG. 4. Herein, in the mounting process of the RFID tag 40, it is possible to simply arrange the RFID tag 40 covered by the protective member 43 in the aforementioned direction, by defining the border region of the plurality of rubber members, the circular shape of the border region B of the carcass ply 23 and shoulder pad 38 shown in FIG. 5A (inner edge shape of the tire-radial direction inside end 38B of the shoulder pad 38), as a reference. In other words, as shown in FIG. 5A, the RFID tag 40 may be pasted so as to substantially match the longitudinal direction of the coating rubber sheets 431, 432 with the tangential line direction of the circular shape of the border region B, with the circular shape of the border region B as a reference.

FIG. 5B is a view showing a modified example of the manufacturing process, and shows a case of pasting while bending the coating rubber sheets 431, 432 covering the RFID tag 40 so as to follow the circular shape of the border region B of the carcass ply 23 and shoulder pad 38. At this time, the coating rubber sheets 431, 432 formed from raw rubber can also be pasted while deforming so as to follow the circumferential direction of the border region B. Using a flexible coil-shaped spring antenna or the like as the antenna of the RFID tag 40, a form such that the antenna also deforms following the deformation of the coating rubber sheets 431, 432 may be established. By way of these methods, it is possible to arrange the RFID tag 40 covered by the protective member 43 simply and accurately in the aforementioned direction, without giving special markers.

FIG. 5C is a view showing the annular rubber sheet 50 as a modified example of the protective member. For example, the RFID tag 40 is interposed by the two annular coating rubber sheets to configure the protective member. In this case, it is preferable to establish a form covering the entire circumference of the border region B of the carcass ply 23 and shoulder pad 38 by the annular rubber sheet 50. It is thereby possible to supplement on the whole the joining between rubber members, i.e. joining between the carcass ply 23 and shoulder pad 38.

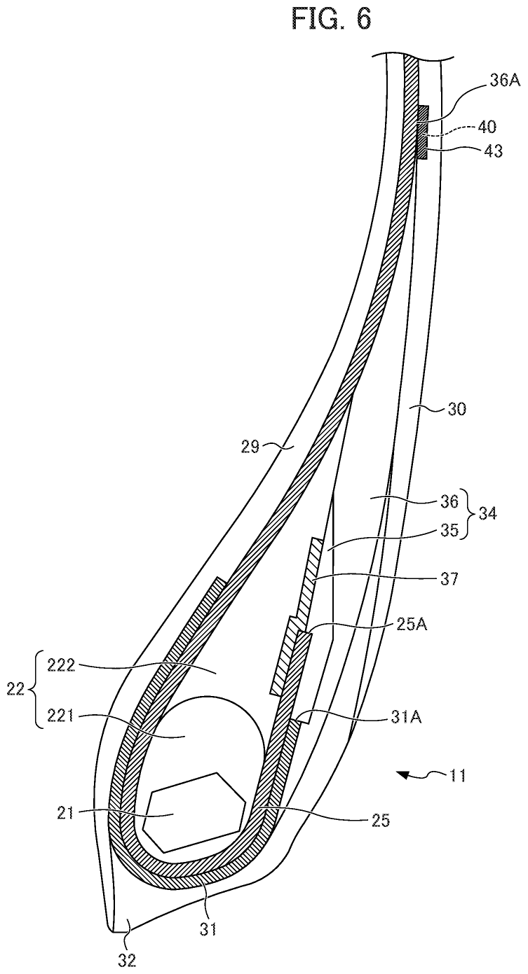

FIG. 6 shows a modified example of the tire 1 of the present embodiment. In a first modified example shown in FIG. 6, the protective member 43 covering the RFID tag 40 is arranged at the intersecting position of the carcass ply 23, second pad 36 and side-wall rubber 30. Then, in the present modified example, the protective member 43 covering the RFID tag 40 is arranged so as to straddle the carcass ply 23 and second pad 36, in the border region of the carcass ply 23 and second pad 36. In other words, the protective member 43 is pasted so as to press from a tire outer surface side the tire-radial direction outside end 36A of the second pad 36 having an end part in a cross-sectional view in the tire-width direction (FIG. 6) that is a tapered shape. Then, regarding the protective member 43, the tire outer surface side is covered by the side-wall rubber 30. Even when arranging the RFID tag 40 at such a position, since the RFID tag 40 is surrounded by a plurality of tire frame members, i.e. the carcass ply 23, second pad 36 and side-wall rubber 30, it is possible to effectively suppress movement of the RFID tag 40 during tire deformation, and suitably protect the RFID tag 40. Then, by defining the border region of a plurality of tire frame members, the border region of the carcass ply 23 and second pad 36 in the present modified example, as a reference for the arrangement position of the RFID tag 40, the variation in arrangement position of the RFID tag 40 decreases. The possibility of the RFID tag 40 being mistakenly arranged at an unpreferable position from an aspect of stress, distortion or the like also decreases, whereby it is possible to appropriately maintain the function of the RFID tag 40.

According to the tire 1 of the present embodiment, the following effects are exerted in addition to the above (1), (2) and (5).

(7) Three tire frame members of the tire 1 according to the present embodiment include: the carcass ply 23 as a first tire frame member configured from a fiber member; the shoulder pad 38 or second pad 28 as a second tire frame member which is arranged so as to cover part over the first tire frame member, and in which an end part in a cross-sectional view in the tire-width direction is configured from a rubber member of tapered shape; and the side-wall rubber 30 as a third tire frame member covering at least a border region of the fiber member and rubber member, in which a coating rubber sheet is arranged so as to straddle the first tire frame member and second tire frame member in the border region of the first tire frame member and second tire frame member, and is covered by the third tire frame member. It is thereby possible to supplement joining of the first tire frame member and second tire frame member, and in the present embodiment, the joining of the carcass ply 23 as the first tire frame member and the shoulder pad 38 or second pad 36 as the second tire frame member.

(8) The manufacturing method for manufacturing the tire 1 according to the present embodiment includes: a step of pasting the coating rubber sheets 431, 432 so as to straddle the first tire frame member and second tire frame member in the border region of the first tire frame member and second tire frame member; and a step of pasting the third tire frame member so as to cover the coating rubber sheets 431, 432 pasted to the border region of the first tire frame member and second tire frame member. It is thereby possible to supplement joining of the first tire frame member and second tire frame member, and in the present embodiment, the joining of the carcass ply 23 as the first tire frame member and the shoulder pad 38 or second pad 36 as the second tire frame member.

(9) With the RFID tag 40 of the tire 1 according to the present embodiment, the RFID tag 40 is arranged at the intersecting position of at least three tire frame members including one fiber member and two rubber members. It thereby becomes possible to mitigate generated stress by the presence of two rubber members, while effectively suppressing movement of the RFID tag 40 by the fiber member.

(10) With the tire 1 according to the present embodiment, the RFID tag 40 is arranged at the intersecting position of the carcass ply 23 as a fiber member, the shoulder pad 38 as a rubber member, and the side-wall rubber 30 as a rubber member. It thereby becomes possible to mitigate the generated stress by the presence of the shoulder pad 38 and side-wall rubber 30, which are contacting rubber members, while effectively suppressing movement of the RFID tag 40 by the fiber member. Then, by defining the border region B of the carcass ply 23 and shoulder pad 38 as a reference for the arrangement position of the RFID tag 40, variation in the arrangement position of the RFID tag 40 decreases.

(11) In the tire 1 according to the present embodiment, the RFID tag 40 is arranged at the intersecting position of the carcass ply 23 as a fiber member, the second pad 36 as a rubber member, and the side-wall rubber 30 as a rubber member. It thereby becomes possible to mitigate the generated stress by the presence of the second pad 36 and side-wall rubber 30, which are rubber members, while effectively suppressing movement of the RFID tag 40 by the fiber member. Then, by defining the border region B of the carcass ply 23 and second pad 36 as a reference for the arrangement position of the RFID tag 40, variation in the arrangement position of the RFID tag 40 decreases.

(12) In the tire 1 according to the present embodiment, the RFID tag 40 is covered by the annular rubber sheet 50, and the annular rubber sheet 50 covers the entire circumference of the border region between the annular first tire frame member and the annular second tire frame member. It is thereby possible to supplement on the whole the joining between the first tire frame member and the second tire frame member. For example, it is possible to supplement on the whole the joining between the carcass ply 23 as the first tire frame member and the shoulder pad 38 or second pad 36 as the second tire frame member.

### Third Embodiment

Next, a tire according to a third embodiment will be explained while referencing the drawings. It should be noted that, in the following explanation, the same reference number will be assigned for configurations which are the same as the first and second embodiments, and detailed explanations thereof will be omitted.

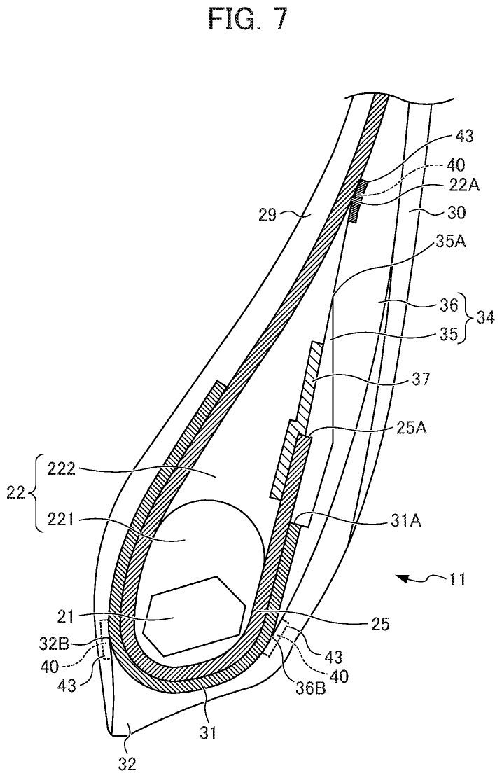

FIG. 7 is an enlarged cross-sectional view showing the vicinity of an embedded part of the RFID tag 40 in the tire 1 according to the present embodiment. As shown in FIG. 7, the RFID tag 40 (including a state in which at least part is covered by the protective member 43) is arranged at the intersecting position of three tire frame members including one fiber member. For example, the tire 1 of the present embodiment includes: the carcass ply 23 as a fiber member, a second bead filler 222 as a rubber member arranged at the tire outer surface side of the carcass ply 23, and the second pad 36 as a rubber member arranged at the tire outer surface side of the carcass ply 23 and second bead filler 222, in which the RFID tag 40 is arranged at the intersecting position of the carcass ply 23, second bead filler 222 and second pad 36.

Then, also in the present embodiment, the RFID tag 40 is more preferably covered by the protective member 43 consisting of coating rubber sheets, and this protective member 43 is arranged at the intersecting position of three tire frame members including one fiber member. More specifically, this protective member 43 is arranged so as to straddle a border region of the carcass ply 23 and second bead filler 222, in the border region between the carcass ply 23 and second bead filler 222. In other words, this protective member 43 is pasted so as to press down the tire-radial direction outside end 22A of the second bead filler 222 having an end part in the cross-sectional view in the tire-width direction (refer to FIG. 7) that is a tapered shape. Then, with this protective member 43, the tire outer surface side is covered by the second pad 36.

Herein, the carcass ply 23, second bead filler 222 and second pad 36 are each a tire frame member of annular shape constituting the tire 1 of annular shape. Then, the protective member 43 retaining the RFID tag 40 is arranged so as to make surface contact with the carcass ply 23, second bead filler 222 and second pad 36.

Even if arranging the RFID tag 40 at such a position, since the RFID tag 40 will be surrounded by the carcass ply 23, second bead filler 222 and second pad 36, it is possible to effectively suppress movement of the RFID tag 40 during tire deformation, and suitably protect the RFID tag 40. In addition, since the RFID tag 40 contacts the second bead filler 222 and second pad 36, while being retained to the carcass ply 23, it becomes possible to mitigate the generated stress by the presence of the second bead filler 222 and second pad 36, which are contacting rubber members, while effectively suppressing movement of the RFID tag 40 by the fiber member. Then, by defining the border region of a plurality of tire frame members, the border region of the carcass ply 23 and second bead filler 222 in the present embodiment, as a reference for the arrangement position of the RFID tag 40, variation in the arrangement position of the RFID tag 40 decreases. The possibility of the RFID tag 40 being arranged mistakenly at an unpreferable position also decreases, and it is thereby possible to appropriately keep the function of the RFID tag 40.

It should be noted that, when setting the modulus of the second pad 36 as a reference, the side-wall rubber 30 is preferably set as a modulus of 0.4 to 0.6 times that of the second pad 36. In addition, the first pad 35 is preferably set as a modulus of 1.1 times to 1.2 times that of the second pad 36. In addition, the second bead filler 222 is preferably set as a modulus of 0.7 to 0.8 times that of the second pad. Then, when defining the modulus of the second pad 36 as the reference, the rim strip rubber 32 is preferably set as a modulus of 0.8 to 1 times that of the second pad 36. Then, the rubber sheet 37 is preferably set as a modulus of 1.1 times to 1.2 times that of the second pad 36. In other words, the modulus of the rubber sheet 37 is preferably set as a modulus substantially equal to the modulus of a portion (first pad 35) of the pad member 34 covering the folding end 25A of the carcass ply 23. By setting such a modulus, it is possible to keep a balance between the flexibility of the tire and the rigidity in the vicinity of the bead 11. It should be noted that the modulus indicates 100% elongation modulus (M100) under a 23° C. atmosphere, measured in accordance with “3.7 stress at a given elongation, S” of JIS K6251:2010.

It should be noted that the RFID tag 40 may be arranged at a position of an end part 32B on the inner side in the tire-width direction of the rim strip rubber 32, i.e. intersecting position of the carcass ply 23, rim strip rubber 32 and inner liner 29, as shown by the dotted line in FIG. 7. Even in this case, the RFID tag 40 comes to be arranged at the intersecting position of three tire frame members including one fiber member. Consequently, it is possible to obtain the aforementioned effects such as suitably protecting the RFID tag 40, and decreasing the variation in arrangement position of the RFID tag 40.

It should be noted that the RFID tag 40 may be arranged at a position of the tire-radial direction inside end 36B of the second pad 36, i.e. intersecting position of the carcass ply 23, second pad 36 and rim strip rubber 36, as shown by the dotted line in FIG. 7. Even in this case, the RFID tag 40 comes to be arranged at the intersecting position of three tire frame members including one fiber member. Consequently, it is possible to obtain the aforementioned effects such as suitably protecting the RFID tag 40, and decreasing the variation in arrangement position of the RFID tag 40.

According to the tire 1 of the present embodiment, the following effects are exerted in addition to the above (1), (2), (5), (7) to (9), and (12).

(13) With the tire 1 according to the present embodiment, the RFID tag 40 is arranged at the intersecting position of the carcass ply 23 as a fiber member, the second bead filler 222 as a rubber member, and the second pad 36 as a rubber member. It thereby becomes possible to mitigate the generated stress by the rubber member, while effectively suppressing movement of the RFID tag 40 by the fiber member. In addition, effects such as the variation in the arrangement position of the RFID tag 40 decreasing are also obtained.

(14) With the tire 1 according to the present embodiment, the RFID tag 40 is arranged at the intersecting position of the carcass ply 23 as a fiber member, the rim strip rubber 32 as a rubber member, and the inner liner 29 as a rubber member. It thereby becomes possible to mitigate the generated stress by the rubber member, while effectively suppressing movement of the RFID tag 40 by the fiber member. In addition, effects such as the variation in the arrangement position of the RFID tag 40 decreasing are also obtained.

(15) With the tire 1 according to the present embodiment, the RFID tag 40 is arranged at the intersecting position of the carcass ply 23 as a fiber member, the second pad 36 as a rubber member, and the rim strip rubber 32 as a rubber member. It thereby becomes possible to mitigate the generated stress by the rubber member, while effectively suppressing movement of the RFID tag 40 by the fiber member. In addition, effects such as the variation in the arrangement position of the RFID tag 40 decreasing are also obtained.

### Fourth Embodiment

Next, a tire according to a fourth embodiment will be explained while referencing the drawings. It should be noted that, in the following explanation, the same reference number will be assigned for configurations which are the same as the first to third embodiments, and detailed explanations thereof will be omitted.

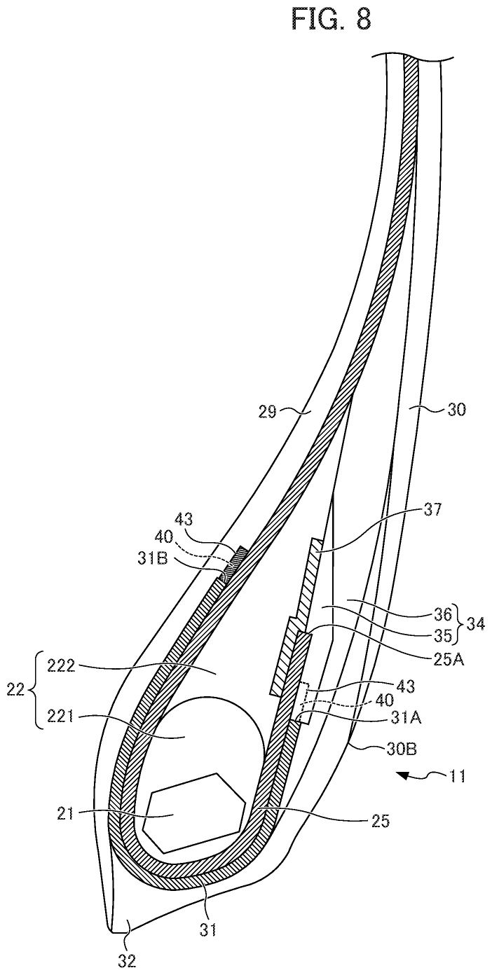

FIG. 8 is an enlarged cross-sectional view showing the vicinity of an embedded part of the RFID tag 40 in the tire 1 of the present embodiment. As shown in FIG. 8, the RFID tag 40 (including a state in which at least part is covered by the protective member 43) is arranged at the intersecting position of three tire frame members including two fiber members. For example, the tire 1 of the present embodiment includes: the carcass ply 23 as a fiber member, the steel chafer 31 as a fiber member, and the inner liner 29 as a rubber member, in which the RFID tag 40 is arranged at the intersecting position of the carcass ply 23, steel chafer 31 and inner liner 29, in a state such that contacts with the end part 31B on the inner side in the tire-width direction of the steel chafer 31.

Then, in the present embodiment, the RFID tag 40 is more preferably covered by the protective member consisting of a coating rubber sheet, and this protective member 43 is arranged at the intersecting position of three tire frame members including two fiber members.

Herein, the carcass ply 23, steel chafer 31 and inner liner 29 are each a tire frame member of annular shape constituting the tire 1 of annular shape. Then, the protective member 43 retaining the RFID tag 40 is arranged so as to contact with the carcass ply 23, steel chafer 31 and inner liner 29.

Even when arranging the RFID tag 40 at such a position, since the RFID tag 40 will be surrounded by three tire frame members including two fiber members, it is possible to effectively suppress movement of the RFID tag 40 during tire deformation, and suitably protect the RFID tag 40. Then, by defining the border region of a plurality of tire frame members as a reference for the arrangement position of the RFID tag 40, variation in the arrangement position of the RFID tag 40 decreases. The possibility of the RFID tag 40 being arranged mistakenly at an unpreferable position also decreases, and it is thereby possible to appropriately keep the function of the RFID tag 40.

It should be noted that the RFID tag 40 may be arranged at the intersecting position of the carcass ply 23, steel chafer 31 and first pad 35, in a state such that contacts the end part 31A on the outer side in the tire-width direction of the steel chafer 31 as shown by the dotted line in FIG. 8. Even in such a case, the RFID tag 40 comes to be arranged at the intersecting position of three tire frame members including two fiber members. Consequently, it is possible to obtain the aforementioned effects such as suitably protecting the RFID tag 40, and decreasing the variation in arrangement position of the RFID tag 40.

According to the tire 1 of the present embodiment, the following effects are exerted in addition to the above (1) to (3), (5), (6) and (12).

(16) With the tire 1 according to the present embodiment, the RFID tag 40 is arranged at the intersecting position of the carcass ply 23 as a fiber member, the steel chafer 31 as a fiber member, and the inner liner 29 as a rubber member. It thereby becomes possible to mitigate the generated stress by the rubber member, while effectively suppressing movement of the RFID tag 40 by the fiber member. In addition, effects such as the variation in the arrangement position of the RFID tag 40 decreasing are also obtained.

(17) With the tire 1 according to the present embodiment, the RFID tag 40 is arranged at the intersecting position of the carcass ply 23 as a fiber member, the steel chafer 31 as a fiber member, and the first pad 35 as a rubber member. It thereby becomes possible to mitigate the generated stress by the rubber member, while effectively suppressing movement of the RFID tag 40 by the fiber member. In addition, effects such as the variation in the arrangement position of the RFID tag 40 decreasing are also obtained.

### Fifth Embodiment

Next, a tire according to a fifth embodiment will be explained while referencing the drawings. It should be noted that, in the following explanation, the same reference number will be assigned for configurations which are the same as the first to third embodiments, and detailed explanations thereof will be omitted.

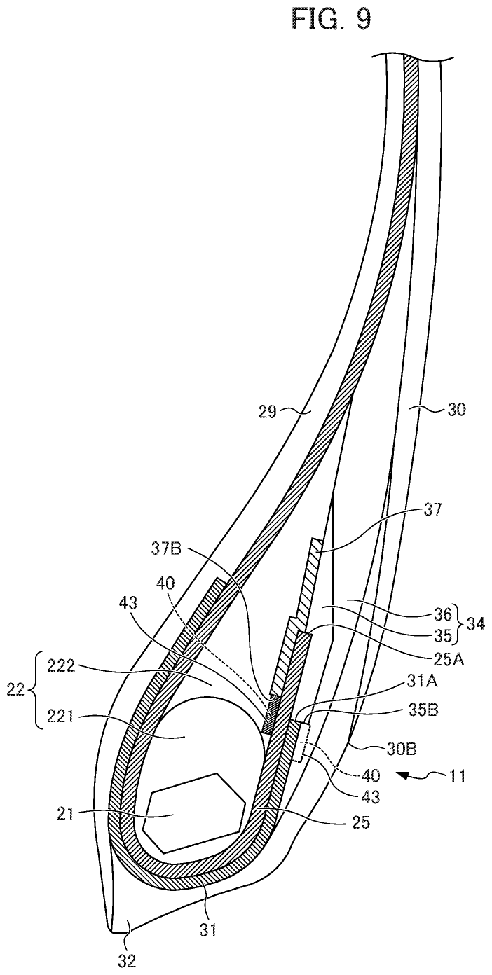

FIG. 9 is an enlarged cross-sectional view showing the vicinity of an embedded part of the RFID tag 40 in the tire 1 according to the present embodiment. As shown in FIG. 9, the RFID tag 40 (including a state in which at least part is covered by the protective member 43) is arranged at the intersecting position of the three tire frame members including one fiber member. More specifically, the tire 1 of the present embodiment includes the carcass ply 23 as a fiber member, the rubber sheet 37 as a rubber member and the second bead filler 222 as a rubber member, in which the RFID tag 40 is arranged at the intersecting position of the carcass ply 23, rubber sheet 37 and second bead filler 222, in a state such that contacts with the tire-radial direction inside end 37B of the rubber sheet 37.

Then, in the present embodiment, the RFID tag 40 more preferably is covered by the protective member 43 consisting of a coating rubber sheet, and this protective member 43 is arranged at the intersecting position of three tire frame members including one fiber member.

Herein, the carcass ply 23, rubber sheet 37 and second bead filler 222 are each a tire frame member of annular shape constituting the tire 1 of annular shape. Then, the protective member 43 retaining the RFID tag 40 is arranged so as to contact with the carcass ply 23, rubber sheet 37 and second bead filler 222.

Even if the RFID tag 40 is arranged at such a position, since the RFID tag 40 will be surrounded by three tire frame members including one fiber member, it is possible to effectively suppress movement of the RFID tag 40 during tire deformation, and suitably protect the RFID tag 40. Then, by defining the border region of a plurality of tire frame members as a reference for the arrangement position of the RFID tag 40, variation in the arrangement position of the RFID tag 40 decreases. The possibility of the RFID tag 40 being arranged mistakenly at an unpreferable position also decreases, and it is thereby possible to appropriately keep the function of the RFID tag 40.

It should be noted that, as shown by the dotted line in FIG. 9, the RFID tag 40 may be arranged at the intersecting position of the steel chafer 31, first pad 35 and second pad 36, in a state such that contacts with the tire-radial direction inside end 35B of the first pad 35. Even in this case, the RFID tag 40 comes to be arranged at the intersecting position of three tire frame members including one fiber member. Consequently, it is possible to obtain the aforementioned effects such as suitably protecting the RFID tag 40, and decreasing the variation in arrangement position of the RFID tag 40.

According to the tire 1 of the present embodiment, the following effects are exerted in addition to the above (1), (2), (5), (9) and (12).

(18) With the tire 1 according to the present embodiment, the RFID tag 40 is arranged at the intersecting position of the carcass ply 23 as a fiber member, the rubber sheet 37 as a rubber member, and the second bead filler 222 as a rubber member. It thereby becomes possible to mitigate the generated stress by the rubber member, while effectively suppressing movement of the RFID tag 40 by the fiber member. In addition, effects such as the variation in the arrangement position of the RFID tag 40 decreasing are also obtained.

(19) With the tire 1 according to the present embodiment, the RFID tag 40 is arranged at the intersecting position of the steel chafer 31 as a fiber member, the first pad 35 as a rubber member, and the second pad 36 as a rubber member. It thereby becomes possible to mitigate the generated stress by the rubber member, while effectively suppressing movement of the RFID tag 40 by the fiber member. In addition, effects such as the variation in the arrangement position of the RFID tag 40 decreasing are also obtained.

### Sixth Embodiment

Next, a tire according to a sixth embodiment will be explained while referencing the drawings. It should be noted that, in the following explanation, the same reference number will be assigned for configurations which are the same as the first to third embodiments, and detailed explanations thereof will be omitted.

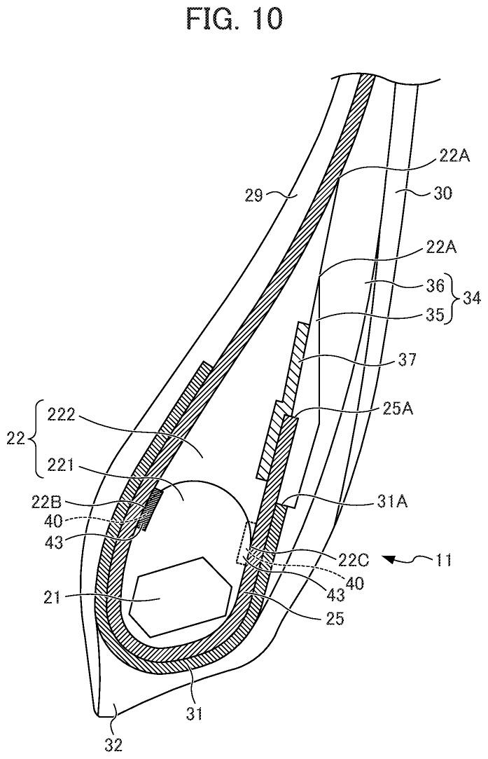

FIG. 10 is an enlarged cross-sectional view of a vicinity of an embedded part of the RFID tag 40 in the tire 1 of the present embodiment. As shown in FIG. 10, the RFID tag 40 (including a state in which at least part is covered by the protective member 43) is arranged at the intersecting position of the three tire frame members including one fiber member. More specifically, the tire 1 of the present embodiment includes the carcass ply 23 as a fiber member, the second bead filler 222 as a rubber member and the first bead filler 221 as a rubber member, in which the RFID tag 40 is arranged at the position 22B on the inner side in the tire-width direction, which is an intersecting position of the carcass ply 23, second bead filler 222 and first bead filler 221.

Then, also in the present embodiment, the RFID tag 40 is more preferably covered by the protective member 43 consisting of coating rubber sheets, and this protective member 43 is arranged at the intersecting position of three tire frame members including one fiber member.

Herein, each of the carcass ply 23, second bead filler 222 and first bead filler 221 is a tire frame member of annular shape constituting the tire 1 of annular shape. Then, the protective member 43 retaining the RFID tag 40 is arranged so as to contact the carcass ply 23, second bead filler 222 and first bead filler 221.

Even if the RFID tag 40 is arranged at such a position, since the RFID tag 40 will be surrounded by three tire frame members including one fiber member, it is possible to effectively suppress movement of the RFID tag 40 during tire deformation, and suitably protect the RFID tag 40. Then, by defining the border region of a plurality of tire frame members as a reference for the arrangement position of the RFID tag 40, variation in the arrangement position of the RFID tag 40 decreases. The possibility of the RFID tag 40 being arranged mistakenly at an unpreferable position also decreases, and it is thereby possible to appropriately keep the function of the RFID tag 40. It should be noted that, as shown by the dotted line in FIG. 10, the RFID tag 40 may be arranged at the position 22C on the outer side in the tire-width direction, which is the intersecting position of the carcass ply 23, second bead filler 222 and first bead filler 221. Even in this case, the RFID tag 40 comes to be arranged at the intersecting position of three tire frame members including one fiber member. Consequently, it is possible to obtain the aforementioned effects such as suitably protecting the RFID tag 40, and decreasing the variation in arrangement position of the RFID tag 40.

According to the tire 1 of the present embodiment, the following effects are exerted in addition to the above (1), (2), (5), (7) to (9), and (12).

(20) With the tire 1 according to the present embodiment, the RFID tag 40 is arranged at an intersecting position of the carcass ply 23 as a fiber member, the second bead filler 222 as a rubber member, and the first bead filler 221 as a rubber member. It thereby becomes possible to mitigate the generated stress by the rubber member, while effectively suppressing movement of the RFID tag 40 by the fiber member. In addition, effects such as the variation in the arrangement position of the RFID tag 40 decreasing are also obtained.

### Seventh Embodiment

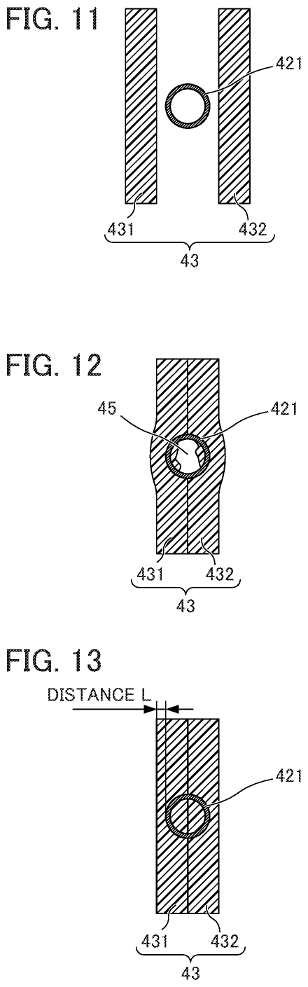

Next, a tire according to a seventh embodiment will be explained while referencing FIGS. 11 to 17. It should be noted that, in the following explanation, the same reference number will be assigned for configurations which are the same as the first to third embodiments, and detailed explanations thereof will be omitted. The present embodiment is a particularly preferable embodiment in the case of the antenna of the RFID tag 40 being a coil-shaped spring antenna.

In the RFID tag 40 of the present embodiment, a coil-shaped spring antenna 421 having high communicability and flexibility can be used as the antenna. The spring antenna 421 is set to an antenna length which was optimized according to the frequency band, etc. to be used.

In the present embodiment, prior to interposing the RFID tag 40 by the two coating rubber sheets 431, 432 constituting the protective member 43, the rubber is arranged within the spring antenna 421. More preferably, rubber is filled into the spring antenna, so that air will not remain as much as possible. This process and the reason for adopting this process will be explained using FIGS. 11 to 17.

First, the state in the vicinity of the RFID tag 40 in the case of not filling rubber inside of the spring antenna 421 will be explained as a reference example using FIGS. 11 to 13. FIG. 11 is a view showing a cross section of the spring antenna 421 and coating rubber sheets 431, 432, prior to interposing the RFID tag 40 by the coating rubber sheets 431, 432. FIG. 12 is a view showing a cross section of the spring antenna 421, coating rubber sheets 431, 432, after interposing the RFID tag 40 by the coating rubber sheets 431, 432.

As shown in FIG. 12, in this reference example, since rubber is not filled into the spring antenna 421 in advance, a certain amount of air 45 may remain within the spring antenna 421 after interposing by the coating rubber sheets 431, 432. If air remains in this way, the integrity of the coating rubber sheets 431, 432 and the spring antenna 421 becomes insufficient, and when the tire deforms, there is concern over the spring antenna 421 not following the motion of the rubber, and the RFID tag 40 having the spring antenna 421 being damaged.

It should be noted that raw rubber before vulcanization is used as the coating rubber sheets 431, 432 herein. Consequently, by pushing the coating rubber sheets 431, 432 from both sides, the coating rubber sheets 431, 432 stick to some extent inside the spring antenna as shown in FIG. 12. However, very large amounts of time and labor are required in order to stick the coating rubber sheets 431, 432 until the inside of the spring antenna is completely embedded.

Then, even if assuming a case of taking time and sticking the rubber sheets until the inside of the spring antenna is embedded, the distance L between the outer circumferential part of the spring antenna 421 and the outer surface of the coating rubber sheets 431, 432 becomes very short, as shown in FIG. 13. In addition, it is difficult to stabilize this distance L, and locally thin portions can occur. Consequently, the protection of the RFID tag 40 by the coating rubber sheets 431, 432 becomes insufficient, and during vulcanization, there is a possibility of the coating rubber sheets 431, 432 being damaged.

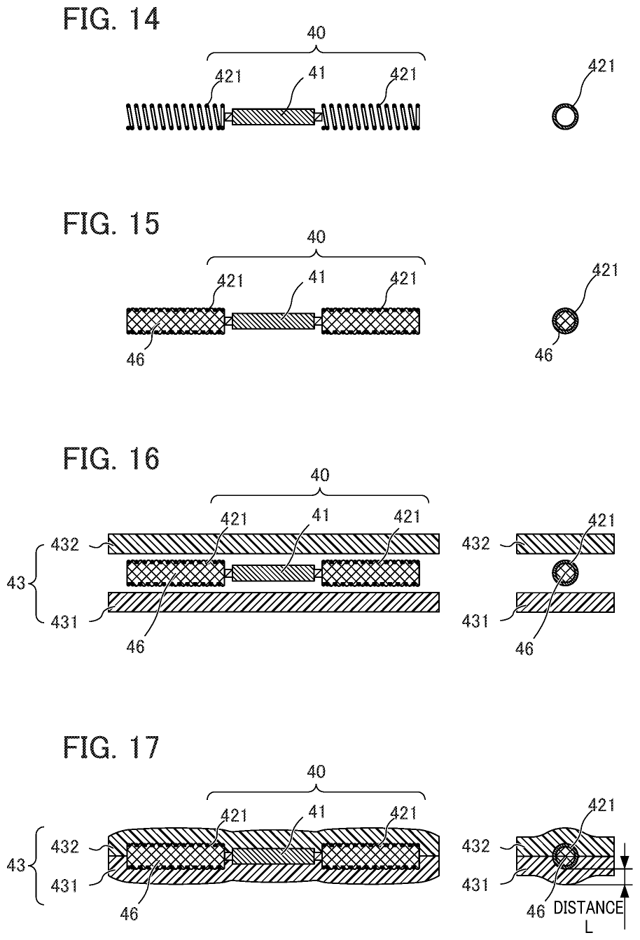

Therefore, in the present embodiment, prior to interposing the RFID tag 40 by the coating rubber sheets 431, 432, the rubber is arranged within the spring antenna 421, as shown in FIGS. 14 to 17. More preferably, rubber is filled within the spring antenna so that air does not remain as much as possible. It should be noted that the views shown on the right sides of FIGS. 14 to 17 are views showing a transverse section of the spring antenna 421 and the surrounding thereof.

FIG. 14 is a view showing a state prior to filling the rubber 46 into the spring antenna 421, and FIG. 15 is a view showing a state after filling the rubber 46 into the spring antenna 421. The rubber 46 is embedded so as to be almost the same outside diameter as the outer circumferential face of the spring antenna 421. Then, in the case of the rubber 46 escaping from the outer circumferential face of the spring antenna 421, it is preferable to wipe off this portion. In other words, the outer circumferential face of the rubber 46 is preferably molded so as to become substantially the same surface as the outer circumferential face of the spring antenna 421. It should be noted that the rubber 46 may be filled into the spring antenna 421, and the outer circumference of the spring antenna 421 may be thinly wrapped by the rubber 46. On the other hand, if thickly wrapping the spring antenna 421 by the rubber 46, in addition to the flexibility of the spring antenna 421 being harmed, the dimension in the width direction formed by the coating rubber sheets 431, 432 after interposing the RFID tag 40 becomes larger, which is not preferable. It should be noted that the rubber 46 may be embedded so as to become substantially the same outside diameter as the inner circumferential face of the spring antenna 421. It is desirable for the outer circumferential part of the rubber 46 to be located within the range of the inner circumferential face and outer circumferential face of the spring antenna 421.

Herein, rubber having flexibility is used as the rubber 46 in order to ensure the flexibility of the spring antenna 421. However, it is preferable to use rubber of a modulus higher than the coating rubber sheets 431, 432 as the rubber 46, in consideration of the workability, etc. It should be noted that preferably unvulcanized rubber is used as the rubber 46 arranged within the spring antenna 421. By establishing the rubber 46 and coating rubber sheets 431, 432 as unvulcanized rubber and vulcanizing simultaneously, the integrity of the rubber 46, coating rubber sheets 431, 432 and spring antenna 421 rises. In addition, the rubber 46, and coating rubber sheets 431, 432 are more preferably established as the same type of rubber. It should be noted that, by emphasizing the flexibility of the spring antenna 421, rubber of lower modulus than the coating rubber sheets 431, 432 may be used as the rubber 46. In addition, rubber of substantially the same modulus, and rubber of the same material may be used. It should be noted that vulcanized rubber may be used as the rubber 46 arranged within the spring antenna 421. In addition, rubber-based adhesive, rubber-based filler, etc. can also be used. Taking account of configuring so as not to leave air within the spring antenna 421 as much as possible, while ensuring flexibility, it is possible to adopt various rubber-based materials. As the arranging operation of the rubber 46, various methods can be adopted; however, for example, it is also possible to inject rubber into the spring antenna 421 using a syringe. In this case, a set appropriate amount of the rubber 46 may be filled using a syringe. In addition, after filling a large amount of the rubber 46, portions protruding from the outer circumference of the spring antenna 421 may be wiped off.

FIG. 16 is a view showing a state prior to interposing the RFID tag 40 into which the rubber 46 is filled in the spring antenna 421, by the coating rubber sheets 431, 432, and FIG. 17 is a view showing a state after interposing by the coating rubber sheets 431, 432.

As shown in FIG. 17, according to the present embodiment, since the rubber 46 is filled in advance into the spring antenna 421, no air pockets exist between the coating rubber sheets 431, 432.

Consequently, since it is unnecessary to be concerned over air pockets, the process of interposing the RFID tag 40 by the coating rubber sheets 431, 432 also becomes easy. In addition, by the rubber 46 being arranged within the spring antenna 421, the integrity of the spring antenna 421, rubber 46, and coating rubber sheets 431, 432 rises, and when the tire deforms, the spring antenna 421 follows the movement of the rubber. Consequently, the durability of the RFID tag 40 having the spring antenna 421 also improves.

In addition, according to the present embodiment, the distance L between the outer circumferential part of the spring antenna 421 and the outer circumferential face of the coating rubber sheets 431, 432 stabilizes. In other words, a distance close to the thickness of the coating rubber sheets 431, 432 is generally secured as this distance L. Consequently, the RFID tag 40 is sufficiently protected by the coating rubber sheets 431, 432. In the present embodiment, the RFID tag 40 interposed by the coating rubber sheets 431, 432 is fixedly set between tire frame members, and subsequently, the green tire is vulcanized.

It should be noted that, in the present embodiment, the RFID tag 40 in which rubber 46 is filled in advanced into the spring antenna 421 is covered by the coating rubber sheets 431, 432, and then arranged between tire frame members. However, the RFID tag 40 in which rubber 46 is filled in advance into the spring antenna 421 may be arranged between tire frame members without covering by the coating rubber sheets 431, 432. By arranging the uncovered RFID tag 40 directly between the tire frame members in this way, the fluctuation in thickness of the rubber member at a portion interposing the RFID tag 40 decreases, and thus the uniformity of the tire improves. In addition, since the rubber 45 is filled in advance into the spring antenna 421, the rubber sheet 37 will not excessively sink into the spring antenna.

According to the tire of the present embodiment, the following effects are exerted in addition to the above (1) to (20).

(21) In the present embodiment, the RFID tag 40 as an electronic unit having a communication function has the spring antenna 421, and a step is included of arranging the rubber 46 in the spring antenna 421, prior to the step of pasting the RFID tag 40 to a tire frame member. Upon the step of interposing the spring antenna 421 of the RFID tag 40 between rubber members, since it becomes unnecessary to be concerned over air pockets, the assembly property becomes favorable.

(22) The present embodiment provides a step of arranging the rubber 46 within the spring antenna 421 of the RFID tag 40 serving as an electronic unit having a communication function; a step of interposing the RFID tag 40 having the spring antenna 421 into which the rubber 46 was arranged, by the coating rubber sheets 431, 432, and an arrangement step of arranging the RFID tag 40 interposed by the coating rubber sheets 431, 432 between tire frame members. The air 45 will thereby not remain inside the spring antenna 421. In addition, since it is unnecessary to be concerned about air pockets, the work of interposing the RFID tag 40 by the coating rubber sheets 431, 432 also becomes simple. In addition, since the distance L between the outer circumferential part of the spring antenna 421 and the outer surface of the rubber sheets 431, 432 is stabilized, the RFID tag 40 is sufficiently protected by the coating rubber sheets 431, 432.

(23) The present embodiment includes: a step of arranging the rubber 46 within the spring antenna 421 of the RFID tag 40 serving as an electronic unit having a communication function; and a step of pasting the rubber sheet 37 to the bead filler 22 so as to interpose the uncoated RFID tag 40 between tire frame members. By interposing the uncoated electronic unit directly between tire frame members in this way, the fluctuation in thickness of the rubber member at the portion interposing the RFID tag 40 decreases, and thus the uniformity of the tire improves. In addition, since the rubber 46 is filled in advance into the spring antenna 421, the rubber sheet 37 will not excessively sink into the spring antenna.

In addition, tire 1 according to embodiments of the present invention also includes the following configuration. A tire 1 according to a first aspect of the present invention includes: tire frame members including bead cores 21, a bead filler 22, an inner liner 29, side-wall rubber 30 and cushion rubber 34, 38; and an electronic unit 40 provided at an interface of tire frame members, in which the electronic unit 40 is disposed between the tire frame members; and a carcass ply 23 extending from one bead core 21 to another bead core 21 and including a rubber-coated reinforcement cord, or a belt 26 provided on an outer side of the carcass ply 23 in a tire-radial direction.

According to a second aspect of the present invention, in the tire as described in the first aspect, the electronic unit 40 is disposed between the carcass ply 23 and the bead filler 22.

According to a third aspect of the present invention, in the tire as described in the second aspect, an annular-shaped sheet 37 is provided in a vicinity of a folding end of the carcass ply 23, and the electronic unit 40 is disposed on an inner side in the tire-radial direction of the annular-shaped sheet 37.

According to a fourth aspect of the present invention, in the tire as described in the third aspect, the bead filler 22 includes: a first bead filler 221 which wraps the bead core 21, and a second bead filler 222 disposed on an outer side in the tire-radial direction of the first bead filler 221, and in which the electronic unit 40 is configured to make contact with an outer end of the first bead filler 221 in the tire-radial direction and the carcass ply 23.

According to a fifth aspect of the present invention, in the tire as described in the first aspect, the cushion rubber is a pad 34 disposed on an outer side in the tire-radial direction of a folding end of the carcass ply 23, and in which the electronic unit 40 is disposed between the carcass ply 23 and the pad 34 such that the electronic unit is configured to make contact with an outer side of the bead filler 22 in the tire-radial direction.

According to a sixth aspect of the present invention, in the tire as described in the fifth aspect, the bead filler 22 includes a first bead filler 221 which wraps the bead core 21, and a second bead filler 222 disposed on an outer side in the tire-radial direction of the first bead filler 221, and in which the electronic unit 40 is configured to make contact with an outer end of the second bead filler 222 in the tire-radial direction.

According to a seventh aspect of the present invention, in the tire as described in the first aspect, the electronic unit 40 is disposed between the carcass ply 23 and the inner liner 29.

According to an eighth aspect of the present invention, in the tire as described in the first aspect may further include: a steel chafer 31 including a steel cord which wraps the bead core 21 and the carcass ply 23, in which the electronic unit 40 is disposed so as to be in the vicinity of or make contact with an inner end of the steel chafer 31 in the tire-width direction.

According to a ninth aspect of the present invention, in the tire as described in the first aspect, the cushion rubber includes a shoulder pad 38 provided between the carcass ply 23 and the belt 26, and in which the electronic unit 40 is configured to make contact with the shoulder pad 38, and at least one of the carcass ply 23 and the belt 26.

According to a tenth aspect of the present invention, in the tire as described in the first aspect, the electronic unit 40 is disposed between the carcass ply 23 and the side-wall rubber 30.

According to an eleventh aspect of the present invention, in the tire as described in the first aspect, the bead filler 22 includes a first bead filler 221 which wraps the bead core 21, and a second bead filler 222 disposed on an outer side of the first bead filler 221 in the tire-radial direction, and in which the electronic unit 40 is disposed between the first bead filler 221 and the carcass ply 23.

According to a twelfth aspect of the present invention, in the tire as described in any one of the first to eleventh aspects, a longitudinal direction of the electronic unit 40 is located along the tire circumferential direction.

According to a thirteenth aspect of the present invention, in the tire as described in any one of the first to twelfth aspects, at least part of the electronic unit 40 is coated with rubber.

It should be noted that, although the tire of the present invention can be adopted as various types of tires such as for cars, light trucks, trucks and buses, it is particularly suitable as a tire of a truck, bus, etc. It should be noted that the present invention is not to be limited to the above-mentioned embodiments, and that even when carrying out modifications, improvements, etc. within a scope capable of achieving the object of the present invention, it is encompassed by the scope of the present invention.

What is claimed is:

1. A tire comprising: tire frame members including bead cores, a bead filler, an inner liner, side-wall rubber and cushion rubber; and an electronic unit provided at an interface of tire frame members, the electronic unit disposed between the tire frame members; and a carcass ply extending from one bead core to another bead core and including a rubber-coated reinforcement cord, or a belt provided on an outer side of the carcass ply in a tire-radial direction.

2. The tire according to claim 1, wherein the electronic unit is disposed between the carcass ply and the bead filler.

3. The tire according to claim 2, wherein an annular-shaped sheet is provided in a vicinity of a folding end of the carcass ply, and the electronic unit is disposed on an inner side in the tire-radial direction of the annular-shaped sheet.

4. The tire according to claim 3,
wherein the bead filler includes: a first bead filler which wraps the bead core, and a second bead filler disposed on an outer side in the tire-radial direction of the first bead filler, and
the electronic unit is configured to make contact with an outer end of the first bead filler in the tire-radial direction and the carcass ply.

5. The tire according to claim 1, wherein the cushion rubber is a pad disposed on an outer side in the tire-radial direction of a folding end of the carcass ply, and
the electronic unit is disposed between the carcass ply and the pad such that the electronic unit is configured to make contact with an outer side of the bead filler in the tire-radial direction.

6. The tire according to claim 5, wherein the bead filler includes a first bead filler which wraps the bead core, and a second bead filler disposed on an outer side in the tire-radial direction of the first bead filler, and
the electronic unit is configured to make contact with an outer end of the second bead filler in the tire-radial direction.

7. The tire according to claim 1, wherein the electronic unit is disposed between the carcass ply and the inner liner.

8. The tire according to claim 1, further comprising a steel chafer including a steel cord which wraps the bead core and the carcass ply, and the electronic unit is disposed so as to be in the vicinity of, or make contact with, an inner end of the steel chafer in the tire-width direction.

9. The tire according to claim 1, wherein the cushion rubber includes a shoulder pad provided between the carcass ply and the belt, and
the electronic unit is configured to make contact with the shoulder pad, and at least one of the carcass ply and the belt.

10. The tire according to claim 1, wherein the electronic unit is disposed between the carcass ply and the side-wall rubber.

11. The tire according to claim 1, wherein the bead filler includes a first bead filler which wraps the bead core, and a second bead filler disposed on an outer side of the first bead filler in the tire-radial direction, and
the electronic unit is disposed between the first bead filler and the carcass ply.

12. The tire according to claim 1, wherein a longitudinal direction of the electronic unit is located along the tire circumferential direction.

13. The tire according to claim 1, wherein at least part of the electronic unit is coated with rubber.
